(19) United States
(12) Patent Application Publication
(10) Pub. No.: US 2026/0139772 A1
(43) Pub. Date: May 21, 2026

(54) ULTRA-HIGH-PRESSURE HOSE JOINT ASSEMBLY AND ASSEMBLY PROCES

(71) Applicant: SHANGHAI FUREX PETROLEUM EQUIPMENT CO., LTD., Shanghai (CN)

(72) Inventor: Lu XU, Shanghai (CN)

(73) Assignee: SHANGHAI FUREX PETROLEUM EQUIPMENT CO., LTD., Shanghai (CN)

(21) Appl. No.: 19/447,964

(22) Filed: Jan. 13, 2026

(30) Foreign Application Priority Data
Feb. 26, 2025 (CN) 202510219152.9
Feb. 26, 2025 (CN) 202510219179.8
Feb. 26, 2025 (CN) 202520319228.0

(51) Int. Cl. F16L 33/22; F16L 33/20; F16L 33/34

(52) U.S. Cl. CPC F16L 33/22; F16L 33/20; F16L 33/34

(57) ABSTRACT

The present disclosure provides an ultra-high-pressure hose joint assembly, including joint components and a tube body. The joint component includes: a mandrel, the tube body being sleeved over the outer side of the mandrel, the mandrel being in communication with the tube body; a connector, at least a part of the connector being sleeved on the mandrel; and a positioning element, the positioning element being located at the connection between the mandrel and the connector, and the positioning element being used to restrict the relative position between the connector and the mandrel. The ultra-high-pressure hose joint assembly in the present disclosure solves the technical problem in the related art that ultra-high-pressure hose joint assemblies are prone to joint leakage.

### CROSS-REFERENCE TO RELATED APPLICATIONS

This application claims priority to Chinese Patent Application No. 202510219179.8, filed on February 26, 2025, Chinese Patent Application No. 202510219152.9, filed on February 26, 2025, and Chinese Patent Application No. 202520319228.0, filed on February 26, 2025, which are hereby incorporated by reference in its entireties.

### TECHNICAL FIELD

The present disclosure relates to the technical field of hydraulic pipeline joints, specifically to an ultra-high-pressure hose joint assembly and an assembly process.

### BACKGROUND

With the development of equipment technology in mining machinery, petroleum equipment, metallurgical forging and pressing, chemical industry, ships, etc., ultra-high-pressure hoses are increasingly used to convey fluid media with relatively high pressure and a certain temperature, with a maximum pressure resistance of up to 200MPa, and even higher pressure resistance requirements under more severe conditions. Traditional hoses and hose joints are connected by threads, relying on the friction force between the thread teeth generated by the initial preload to achieve locking. Alternating transverse loads generated by high-frequency vibration can cause tiny relative displacement between the thread teeth. After long-term repetition, the initial preload gradually attenuates, eventually leading to unthreading. Pressure fluctuations under ultra-high pressure superimpose axial impact loads, aggravating fatigue damage to the thread teeth, while destroying the friction balance between the thread teeth, accelerating unthreading. Simultaneously, high-frequency vibration leads to preload relaxation. Axial alternating loads generated by pressure fluctuations cause repeated deformation at the connection, which in turn creates micro-gaps at the sealing surface. There are significant differences in stiffness and thermal expansion coefficients between the hose and the joint. High-frequency vibration can cause fatigue cracks at the connection, and temperature changes produce additional stress. Both can destroy the sealing contact, eventually forming leakage. While leaking, external dust can also enter the hose, causing hydraulic system failure, further increasing maintenance and repair costs.

In view of the above problems, there is an urgent need for a joint structure that can effectively achieve reliable connection and stable sealing in an ultra-high-pressure environment.

Invention patent JP2024136837A discloses a joint structure for a spiral corrugated hose, comprising a metal joint inserted into the hose end, a fixing sleeve compressing the hose, a cylindrical member made of a thermosetting elastomer covering the outside of the hose, having spiral grooves on its inner surface matching the ridges of the hose, and a spiral ring formed by spirally wound metal wire, which is arranged in the valleys of the hose. By providing a pressing member and a spiral ring with higher hardness than the hose body, sealing performance and anti-detachment performance are maintained under thermal cycling conditions. Its existing problem is that the spiral ring only relies on physical interlocking in the hose valleys to provide anti-detachment resistance, and does not solve the interfacial stress concentration caused by stiffness differences between the metal joint and the hose. Under long-term combined action of high-pressure pulsation and vibration, it is still prone to cause sealing failure and fatigue cracking.

Invention patent JP2016118244A discloses an embedded hoop, which is provided with a mechanism on the inner cylinder part and/or the covering part for temporarily fixing the axial position of the tube before crimping. The position of this temporary fixing mechanism must be deeper than the front-end position of the tube insertion confirmation part on the tube insertion side. When the tube is inserted and contacts this mechanism, a noticeable "sense of being in place" or resistance is generated, and it is temporarily fixed at the same time, preventing its movement during subsequent crimping operations, effectively preventing problems such as insecure connection and sealing failure caused by incomplete tube insertion or displacement during crimping. However, the temporary fixing mechanism of this patent is external or based on a large-diameter part of the inner cylinder, and its structure relies on the mechanical bite between the outer wall of the tube and the inner wall of the hoop. After temporary fixation, an additional crimping process is still required. Uneven crimping can cause local stress concentration, leading to hose deformation and rupture or insufficient preload on the sealing surface. Under dynamic loads, it is prone to fretting wear and gap leakage, and long-term use reliability is limited.

### SUMMARY

The object of the present disclosure is to overcome the above technical deficiencies and provide an ultra-high-pressure hose joint assembly and an assembly process to solve the technical problem in the related art that ultra-high-pressure hose joint assemblies are prone to joint leakage.

To achieve the above technical object, the present disclosure adopts the following technical solution: providing an ultra-high-pressure hose joint assembly, comprising joint components and a tube body. The joint component comprises: a mandrel, the tube body being sleeved over the outer side of the mandrel, the mandrel being in communication with the tube body; a connector, at least a part of the connector being sleeved on the mandrel; a positioning element, the positioning element being located at the connection between the mandrel and the connector, the positioning element being used to restrict the relative position between the connector and the mandrel.

Further, an installation space for inserting the tube body is formed between the connector and the mandrel, and the connector is fixedly connected to the outer side of the tube body located within the installation space.

Further, a positioning groove is provided on the mandrel, one end of the positioning element abuts against the connector, and the other end of the positioning element abuts against the positioning groove.

Further, the connector comprises a limiting groove corresponding to the positioning groove, the limiting groove abuts against the positioning element, the limiting groove and the positioning groove together enclose to form an annular retention channel for accommodating the positioning element, and the positioning element is in interference fit with the annular retention channel.

Further, the annular retention channel is an annular channel, and the positioning element is in interference fit with the annular channel.

Further, the connector comprises: installation holes, the installation holes penetrating through the connector, the installation holes being in communication with the annular retention channel, the positioning element entering the annular retention channel through the installation holes; plugging members, the plugging members being detachably connected to the installation holes.

Further, the tube body comprises multiple layers of reinforcement layers and an intermediate rubber layer covering the multiple layers of reinforcement layers.

Further, first rubber receiving grooves are provided on a side of the connector close to the tube body, and at least a portion of the intermediate rubber layer is located within the first rubber receiving grooves.

Further, the joint component comprises a first crimping sleeve, and the first crimping sleeve is embedded within the multiple layers of reinforcement layers.

Further, the mandrel and the first crimping sleeve are connected by a snap-fit structure.

Further, the mandrel comprises a plurality of axially spaced annular shoulders with successively reduced diameters, at least one layer of the reinforcement layers is distributed on each shoulder, and at least one layer of the reinforcement layers is fixedly connected to the shoulder.

Further, the joint component comprises a second crimping sleeve, the second crimping sleeve being sleeved over the outer side of the tube body; the second crimping sleeve and the connector are connected by a crimping structure.

Further, rubber injection holes are provided on the peripheral wall of the connector, the rubber injection holes being used to inject rubber material into the installation space to form the intermediate rubber layer through vulcanization.

Further, it further comprises elastic parts, the elastic parts being disposed between the plugging members and the positioning element; both ends of each elastic part respectively abut against each plugging member and the positioning element.

Further, sealing ring grooves are provided on the peripheral wall at the end of the connector, sealing rings are provided within the sealing ring grooves; a retaining ring or a C-ring is respectively arranged on both sides of each sealing ring; the contact surface of the retaining ring or the C-ring on the side close to each sealing ring is an inclined surface.

The present disclosure also provides an assembly process, applicable to the described ultra-high-pressure hose joint assembly, comprising:

sleeving the connector onto a hose joint main body, so that after the connector and the hose joint main body are sleeved in place, an annular retention channel for installing a positioning element is formed between the connector and the hose joint main body;

installing the positioning element into the formed annular retention channel;

injecting rubber into the gap between the connector and the hose joint main body, followed by vulcanization treatment, to obtain an ultra-high-pressure hose joint assembly.

Further, sleeving the connector onto a hose joint main body, so that after the connector and the hose joint main body are sleeved in place, an annular retention channel for installing a positioning element is formed between the connector and the hose joint main body, comprises the following steps:

sleeving the connector onto the hose joint main body;

aligning the limiting groove on the connector with the positioning groove on the hose joint main body, thereby forming the annular retention channel between the connector and the hose joint main body after the connector and the hose joint main body are sleeved in place.

Further, installing the positioning element into the formed annular retention channel comprises the following steps:

installing a plurality of the positioning elements into the annular retention channel in sequence through the installation holes located on the connector;

after all of the plurality of positioning elements are installed, plugging the installation holes with plugging members.

Further, before sleeving the connector onto the hose joint main body, it comprises the following steps:

preparing a hose without an outer rubber layer, sleeving a first crimping sleeve and a mandrel onto the hose without the outer rubber layer in sequence;

fixedly connecting the hose without the outer rubber layer with the first crimping sleeve and the mandrel respectively;

winding the reinforcement layer by layer onto the surface of the hose without the outer rubber layer, thereby forming multiple layers of reinforcement layers on the hose, at least one layer of the reinforcement layers being distributed on each shoulder located on the mandrel, fixedly connecting at least one layer of the reinforcement layers to the corresponding shoulder; winding a layer of intermediate rubber on the surface of each reinforcement layer to form the hose joint main body.

Further, injecting rubber into the gap between the connector and the hose joint main body comprises the following steps:

injecting rubber into the gap between the connector and the hose joint main body through rubber injection holes to form an intermediate rubber layer, until rubber continuously overflows from rubber overflow holes without any bubbles are present;

sealing the rubber injection holes and the rubber overflow holes with plugs.

### Beneficial Effects:

1. By providing a positioning element at the connection between the connector and the hose joint in the present disclosure, the positioning element restricts the relative position between the connector and the mandrel from the inside out, keeping the relative position between the connector and the mandrel unchanged. When the service environment has large pressure fluctuations or high-frequency vibration, it prevents the connector and the mandrel from performing irregular movements under external forces. The above setting achieves anti-loosening treatment, avoiding relative displacement of the joint caused by alternating loads generated by high-frequency vibration and high-pressure fluctuations, leading to thread backing off, damage or failure of the seal, resulting in a decrease in sealing capability, thereby maintaining the sealing between the joint component and the tube body, enabling it to work stably and efficiently in high-pressure, high-frequency vibration environments, meeting the requirements of ultra-high-pressure hoses for resisting ultra-high-pressure pulsation and withstanding ultra-high pressure, and solving the technical problem in the related art that ultra-high-pressure hose joint assemblies are prone to joint leakage.

2. The limiting groove and the positioning groove form an annular retention channel for accommodating the positioning element, and the positioning element is in interference fit with the annular retention channel. The positioning element always remains in the annular retention channel and cannot escape, restricting the relative position between the connector and the hose joint main body from the inside out, preventing the positioning element from moving back and forth in the annular retention channel and causing misalignment movement between the connector and the mandrel, achieving circumferential positioning, axial positioning, and radial positioning of the connector, effectively avoiding damage to the seal between the connector and the hose joint main body, and further improving the sealing performance of the hose joint.

3. In the present disclosure, there is an intermediate rubber layer between the connector and the hose joint main body. The intermediate rubber layer is formed by injecting rubber and vulcanizing during the assembly process at the connection between the connector and the hose joint main body. The injected rubber layer penetrates the gaps of the multiple winding layers and fills the gaps at the connection, bonding the connector and the hose joint main body into one body, forming a dense composite structure, effectively transmitting loads and dispersing stress, and enhancing the stability of the seal.

4. In the present disclosure, first rubber receiving grooves are provided on the side of the connector close to the tube body to accommodate part of the intermediate rubber layer, enhancing the gripping force on the intermediate rubber layer, improving the adhesion of the intermediate rubber layer, ensuring that the rubber layer formed after injection and vulcanization is firmly embedded in the groove body, forming an interlocking structure, preventing interface peeling, enabling the entire joint structure to maintain excellent fatigue resistance under high-temperature and high-pressure alternating conditions, significantly reducing leakage risk, and improving system durability and safety.

5. Elastic parts are provided between the plugging members and the positioning element to prevent "fretting wear" of the positioning element under high-frequency vibration, and to dynamically adjust the contact pressure of the plugging members, ensuring that the sealing surface always keeps conforming contact and preventing leakage, improving the sealing performance of the pipeline.

6. The present disclosure adopts various methods to improve the connection strength and sealing performance between the connector and the tube body. By providing an annular retention channel between the connector and the hose joint main body, with the positioning element in interference fit with the annular retention channel, the positioning element always remains in the annular retention channel and cannot escape, achieving full-directional limitation of the connector in the circumferential, axial, and radial directions, effectively preventing position deviation caused by vibration or pressure impact during usage; combined with the multi-layer winding layer reinforcement structure, shoulder anchoring design, and snap-fit fixation of the first crimping sleeve, the relative movement between the tube body and the joint is further suppressed; and by injecting rubber and vulcanizing, the components are formed into an integrated structure, significantly improving connection strength and sealing stability, enabling reliable operation under high-temperature, high-pressure, and high-frequency vibration conditions; the provision of the second crimping sleeve not only enhances external protection but also achieves sealing of the intermediate rubber layer, preventing moisture and chemical media from invading the interface and extending joint life; meanwhile, the preloading effect of the elastic parts between the plugging members and the positioning element effectively compensates for gap caused by assembly errors and material thermal expansion and contraction, ensuring long-term stable contact of the sealing interface, and maintaining high sealing under alternating loads, further improving the reliability and durability of the joint under complex working conditions. Through the synergistic effect of multiple protection and limitation mechanisms, the present disclosure significantly improves the connection reliability and sealing durability of the hose joint under extreme working conditions, effectively solving the problems of connection loosening and sealing failure in traditional joints caused by vibration and pressure impact, and achieving highly reliable connection in ultra-high-pressure environments.

### BRIEF DESCRIPTION OF THE DRAWINGS

FIG. 1 is a schematic structural diagram of the ultra-high-pressure hose joint assembly adopted in an embodiment of the present disclosure;

FIG. 2 is a partial structural schematic diagram of the ultra-high-pressure hose joint assembly adopted in an embodiment of the present disclosure;

FIG. 3 is a flowchart of the assembly process adopted in an embodiment of the present disclosure.

In the above figures, the reference numerals include:

1. joint component; 11. mandrel; 111. positioning groove; 112. snap-fit groove; 113. shoulder; 114. sealing groove; 12. connector; 121. limiting groove; 122. installation hole; 123. plugging member; 124. abutment portion; 125. first rubber receiving groove; 126. rubber injection hole; 127. rubber overflow hole; 128. groove; 13. positioning element; 14. first crimping sleeve; 141. second rubber receiving groove; 142. snap-fit block; 15. second crimping sleeve; 151. protrusion; 2. tube body; 21. reinforcement layer; 22. intermediate rubber layer; 3. sealing ring.

### DETAILED DESCRIPTION OF THE EMBODIMENTS

In order to enable those skilled in the art to better understand the solutions of the present application, the embodiments of the present application will be clearly and completely described below with reference to the accompanying drawings. Obviously, the described embodiments are only a part of the embodiments of the present application, not all of them. Based on the embodiments in the present application, all other embodiments obtained by ordinary persons skilled in the art without creative work shall fall within the scope of protection of the present application.

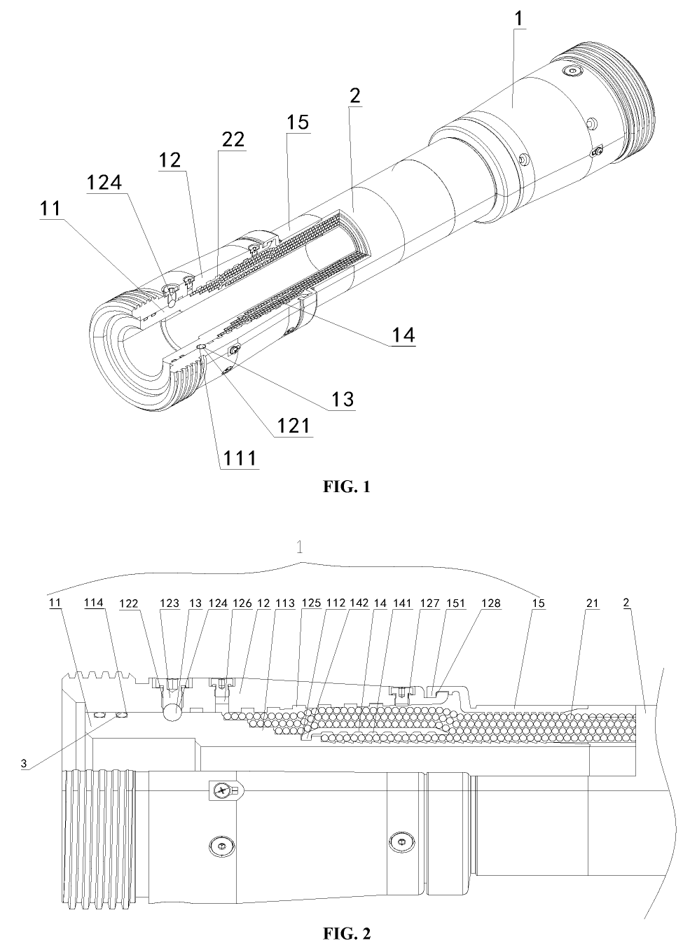

According to an embodiment of the present disclosure, an ultra-high-pressure hose joint assembly is provided. Referring to FIGS. 1 to 3, it comprises joint components 1 a tube body 2. Each joint component 1 comprises: a mandrel 11, the tube body 2 being sleeved over the outer side of the mandrel 11, the mandrel 11 being in communication with the tube body 2; a connector 12, an installation space for inserting the tube body 2 being formed between the connector 12 and the mandrel 11, the connector 12 being fixedly connected to the outer side of the tube body 2 located within the installation space, at least a part of the connector 12 being sleeved on the mandrel 11; a positioning element 13, the positioning element 13 being located at the connection between the mandrel 11 and the connector 12, the positioning element 13 being used to restrict the relative position between the connector 12 and the mandrel 11.

By restricting the relative position between the connector 12 and the mandrel 11 through the positioning element 13, the relative position between the connector 12 and the mandrel 11 is kept unchanged. When the usage environment has large pressure fluctuations or high-frequency vibration, it prevents the connector 12 and the mandrel 11 from performing irregular movements under external forces. The above setting achieves anti-loosening treatment, avoiding relative displacement of the joint leading to thread backing off, damage or failure of the seal, resulting in a decrease in sealing capability, thereby maintaining the sealing between the joint component 1 and the tube body 2, enabling it to work stably and efficiently in high-pressure, high-frequency vibration environments, meeting the requirements of ultra-high-pressure hose joint for resisting ultra-high-pressure pulsation and withstanding ultra-high pressure, and solving the technical problem in the related art that ultra-high-pressure hose joint assemblies are prone to joint leakage.

In the ultra-high-pressure hose joint assembly of this embodiment, referring to FIG. 1, a positioning groove 111 is provided on the mandrel 11. One end of the positioning element 13 abuts against the connector 12, and the other end of the positioning element 13 abuts against the positioning groove 111. Specifically, the positioning element 13 abuts against both the positioning groove 111 and the connector 12. By providing the positioning groove 111, the positioning element 13 is embedded in the positioning groove 111, thereby restricting the axial and radial movement of the connector 12, keeping the axes of the mandrel 11 and the connector 12 always concentric, preventing the connector 12 from moving axially relative to the mandrel 11, thus achieving axial and radial positioning of the connector 12.

In the ultra-high-pressure hose joint assembly of this embodiment, referring to FIG. 1, the connector 12 comprises a limiting groove 121 corresponding to the positioning groove 111. The limiting groove 121 abuts against the positioning element 13. The limiting groove 121 and the positioning groove 111 together enclose to form an annular retention channel for accommodating the positioning element 13. The positioning element 13 is in interference fit with the annular retention channel. Specifically, by providing the limiting groove 121, the contact area between the positioning element 13 and the connector 12 is increased, further restricting the relative position of the connector 12.

The limiting groove 121 and the positioning groove 111 form an annular retention channel for accommodating the positioning element, and the positioning element 13 is in interference fit with the annular retention channel, preventing the positioning element 13 from moving back and forth in the annular retention channel and causing misalignment movement between the connector 12 and the mandrel 11, achieving circumferential, axial, and radial positioning of the connector 12, further improving the sealing performance of the hose joint.

It should be noted that in the prior art, positioning pin structures are usually used to position the connector 12, by using a positioning pin fixed on the connector 12 abutting against the mandrel 11. However, when this structural form is applied to high-pressure and high-vibration environments, the positioning pin is very prone to loosening and displacement, causing gaps between the positioning pin and the connector, thereby causing the connector 12 to shift relative to the mandrel 11. In the ultra-high-pressure hose joint assembly of this embodiment, both ends of the positioning element 13 always maintain contact with the connector 12 and the mandrel 11. The positioning element 13 always remains in the annular retention channel and cannot escape, effectively avoiding damage to the seal, improving the problem of joint leakage in the prior art.

In the ultra-high-pressure hose joint assembly of this embodiment, referring to FIG. 2, the connector 12 comprises: installation holes 122, the installation holes 122 penetrating through the connector 12, the installation holes 122 being in communication with the annular retention channel, the positioning element 13 entering the annular retention channel through the installation holes 122; plugging members 123, the plugging members 123 being detachably connected to the installation holes 122. Specifically, the installation holes 122 are used to allow the positioning element 13 to enter the annular retention channel, and the plugging members 123 are used to plug the installation holes 122 to prevent the positioning element 13 from escaping from the installation holes 122.

Specifically, because the positioning element 13 is in interference fit with the annular retention channel, external force is applied to drive the positioning element 13 into the annular retention channel during installation.

In some embodiments, the positioning element 13 is positioning balls, and the annular retention channel is an annular raceway distributed on the mandrel 11 and the connector 12.

In some embodiments, the positioning element 13 comprises multiple pieces, all of which are located within the annular retention channel. Multiple positioning elements 13 increase the contact area between the positioning element 13 and the annular retention channel, further preventing relative displacement between the connector 12 and the mandrel 11, further improving the sealing performance between the joint component 1 and the tube body 2.

It can be understood that because the positioning element 13 is in interference fit with the annular retention channel, the positioning element 13 is difficult to move in the annular retention channel. Therefore, multiple installation holes 122 are provided on the connector 12 to reduce the moving distance of the positioning element 13 in the annular retention channel, facilitating the assembly of the positioning element 13.

It can be understood that when the positioning element 13 is positioning balls, the annular retention channel includes but is not limited to a circular channel, and can also be set as a V-shaped channel or polygonal channel according to the shape of the positioning element 13.

In some embodiments, the annular retention channel can be an annular channel, and the positioning element 13 is in interference fit with the annular channel.

In some embodiments, the positioning element 13 is a combination structure of balls and springs. The annular retention channel includes a cavity accommodating the balls and guide sections guiding the compression of the springs. The springs provide continuous preload, keeping the balls always pressed against the inner wall of the connector 12, achieving dynamic adaptive positioning. When the tube body is disturbed axially or radially, the balls can roll slightly within the cavity, adjusting the contact position, effectively alleviating stress concentration, and improving sealing stability. This structure is suitable for high-frequency vibration environments, can maintain reliable connection performance under temperature changes and mechanical shock, and extends the service life of the joint component.

In some embodiments, the positioning element 13 is an expansion sleeve, and the annular retention channel is an annular through-hole formed by the mandrel 11 and the connector 12 together. The expansion sleeve is pressed into the annular through-hole by interference fit during installation. Its outer wall closely fits the inner wall of the connector, and its inner wall firmly contacts the outer wall of the mandrel, achieving bidirectional limitation. This structure not only effectively disperses stress, avoiding local wear, but also remains stable under high-pressure impact and severe vibration, preventing relative sliding. During disassembly, the expansion sleeve can be radially contracted by special tools and then removed, facilitating maintenance and replacement. The expansion sleeve enables the joint to maintain preload when subjected to alternating loads, avoiding sealing failure caused by loosening, and improving the reliability and durability of the joint under complex working conditions.

In some embodiments, the positioning element 13 is an elastic snap ring, and the annular retention channel is an annular groove. The elastic snap ring is embedded in the annular groove and generates radial preload to achieve axial positioning. During assembly, the elastic snap ring is compressed and contracted to enter the annular groove, and relies on its own elasticity to restore and closely fit with the groove wall. The structure is simple and easy to disassemble and assemble. The elastic snap ring can effectively absorb vibration impact, reduce the requirement for the coaxiality of the connector 12 and the mandrel 11, and reduce the risk of stress concentration.

In some embodiments, the positioning element 13 is a conical ring with an inclined surface, and the annular retention channel is a conical hole matching it. During assembly, the conical ring is radially expanded by axial compression, tightly contacted to both the inner wall of the connector and the outer wall of the mandrel, forming double-sided friction locking. This structure can maintain stable preload under vibration and impact loads, prevent loosening, and is easy to disassemble and replace.

In the ultra-high-pressure hose joint assembly of this embodiment, referring to FIG. 2, the plugging member 123 is provided with an abutment portion 124 for abutting against the positioning element 13. Specifically, the abutment portion 124 is a spherical surface conforming to the shape of the positioning element 13 to increase the contact area between the abutment portion 124 and the positioning element 13, thereby limiting the positioning element 13 at the installation hole 122 and preventing the positioning element 13 from moving.

In some embodiments, an elastic part is provided between the plugging member 123 and the positioning element 13. Both ends of the elastic part respectively abut against the plugging member 123 and the positioning element 13 to prevent "fretting wear" of the positioning element 13 under high-frequency vibration, dynamically adjust the contact pressure of the plugging member, ensure that the sealing surface always fits, preventing leakage, and improving the sealing performance of the pipeline.

The inner end surface of the plugging member is provided with an elastic part installation groove, and the elastic part is arranged in the elastic part installation groove. At this time, the positioning element 13 is in clearance fit with the annular retention channel. Exemplarily, the pre-compression amount of the elastic part is set within the range of -40°C to 150°C, and the balls always maintain an interference amount of 0.05–0.15 mm; the plugging member 123 adopts a double sealing structure: an outer O-ring for dust prevention, and an inner metal sealing surface contacting the elastic element.

Exemplarily, the elastic part is a disc spring or a stainless steel bellows.

In some embodiments, both the mandrel 11 and the connector 12 are made of stainless steel material, giving them not only high mechanical strength and wear resistance but also good corrosion resistance.

In some embodiments, a threaded structure is provided on the connector 12 to facilitate the assembly and replacement of the joint. Preferably, the threaded structure of the connector 12 adopts Acme trapezoidal threads, giving it not only high mechanical strength but also facilitating the assembly and replacement of the joint component 1. At the same time, its connection method can be designed as a flange or other tapered seal connection method according to user requirements.

In the ultra-high-pressure hose joint assembly of this embodiment, referring to FIG. 1-2, the tube body 2 comprises multiple layers of reinforcement layers 21 and an intermediate rubber layer 22 covering the multiple layers of reinforcement layers 21. The intermediate rubber layer 22 is formed by injecting rubber and vulcanizing during the assembly process between the connector 12 and the tube body 2. The injected rubber penetrates the gaps of the multiple reinforcement layers 21 and fills the gaps at the connection, bonding the connector 12 and the tube body 2 into one body, forming a dense composite structure, effectively transmitting loads and dispersing stress, and enhancing the stability of the seal.

In the ultra-high-pressure hose joint assembly of this embodiment, referring to FIG. 2, first rubber receiving grooves 125 are provided on a side of the connector 12 close to the tube body 2, and at least a portion of the intermediate rubber layer 22 is located within the first rubber receiving grooves 125. Specifically, by providing the first rubber receiving grooves 125 to accommodate part of the intermediate rubber layer 22, the grip strength on the intermediate rubber layer 22 is enhanced, the adhesion of the intermediate rubber layer 22 is improved, ensuring that the rubber layer formed after injection and vulcanization is firmly embedded in the groove body, forming an interlocking structure, preventing interface peeling, enabling the entire joint structure to maintain excellent fatigue resistance under high-temperature and high-pressure alternating conditions, significantly reducing leakage risk, and improving system durability and safety.

In some embodiments, the intermediate rubber layer is a functionally graded intermediate rubber layer. The side near the connector is high-hardness, high-modulus rubber (such as high-acrylonitrile NBR), improving the bonding strength with the metal; the middle layer is medium-hardness rubber as a transition layer; the side near the steel wire layer is low-hardness, high-elasticity rubber, matching the deformation of the winding layers. The functionally graded intermediate rubber layer adopts co-extrusion and segmented vulcanization processes to achieve the gradient structure.

Specifically, the tube body 2 further comprises an inner rubber layer and an outer rubber layer arranged on the inner and outer sides of the intermediate rubber layer 22.

Specifically, the first rubber receiving groove 125 is an annular depression provided on the connector 12. The winding connection line between the connector 12 and the tube body 2 can increase the sealing performance of the joint. The cross-section of the first rubber receiving groove 125 includes but is not limited to shapes such as rectangle, trapezoid, parallelogram, etc.

In some embodiments, multiple first rubber receiving grooves 125 are distributed along the axial direction of the connector 12 to increase the grip ability. The provision of multiple first rubber receiving grooves enables the intermediate rubber layer to form multiple embedded snap structures on the surface of the connector, significantly improving the friction and pull-out resistance at the interface. At the same time, each rubber receiving groove can store part of the rubber material, promoting the cross-linking and curing of the rubber layer during the vulcanization process, further enhancing the bonding strength.

In some embodiments, the reinforcement layers 21 are steel wire layers, having strong strength and flexibility.

In some embodiments, non-metallic materials such as carbon fiber filaments or ceramic materials can be used to replace the steel wire layers in the tube body 2. Using non-metallic materials can also meet the requirements of the tube body 2 for strength and toughness, reduce the weight of the tube body 2, improve the corrosion resistance and high-temperature resistance of the tube body 2, and at the same time, not be detected by metal detectors in special application environments, having special application significance.

In the ultra-high-pressure hose joint assembly of this embodiment, referring to FIG. 1-2, the joint component 1 comprises a first crimping sleeve 14, and the first crimping sleeve 14 is embedded within the multiple layers of reinforcement layers 21. Specifically, by providing the first crimping sleeve 14, which is embedded within the multiple layers of reinforcement layers 21, the structural strength of the tube body 2 is increased. The first crimping sleeve 14 tightly clamps the reinforcement layers, effectively transmitting stress and preventing local delamination or loosening. After rubber injection, the first crimping sleeve 14, the reinforcement layers 21, and the intermediate rubber layer 22 form a dense integrated structure, significantly improving the overall mechanical performance of the tube body 2.

Specifically, reinforcement layers 21 are laid on the side of the first crimping sleeve 14 away from the mandrel 11. Several second rubber receiving grooves 141 are provided on the side of the first crimping sleeve 14 close to the mandrel 11. There is at least one layer of steel wire ring and at least a portion of the intermediate rubber layer 22 between the first crimping sleeve 14 and the mandrel 11. The first crimping sleeve 14 is embedded into the tube body 2 before forming the intermediate rubber layer 22, making the connection between the first crimping sleeve 14 and the tube body 2 stable, preventing the first crimping sleeve 14 from loosening and falling off, enhancing external protection, achieving sealing of the intermediate rubber layer, preventing moisture and chemical media from invading the interface, and extending joint life.

In the ultra-high-pressure hose joint assembly of this embodiment, referring to FIG. 2, the mandrel 11 and the first crimping sleeve 14 are connected by a snap-fit structure. The snap-fit structure comprises: a snap-fit groove 112, the snap-fit groove 112 being provided on the mandrel 11; a snap-fit block 142, the snap-fit block 142 being provided on the first crimping sleeve 14, the snap-fit block 142 engaging with the snap-fit groove 112. Through the above setting, by providing the snap-fit structure, the snap-fit block 142 is pressed into the snap-fit groove 112 through the crimping process, allowing the first crimping sleeve 14 to be "hung" on the mandrel 11, making the first crimping sleeve 14 and the mandrel 11 one body, and thus making the tube body 2 and the mandrel 11 one body, increasing the connection strength between the tube body and the mandrel 11, and preventing the tube body 2 from detaching from the joint component 1.

It can be understood that the connection between the tube body 2 and the joint component 1 is a key flow-through position. By arranging the first crimping sleeve 14 at the connection between the tube body 2 and the joint component 1, the structural strength of the tube body can be increased. At the same time, the second rubber receiving grooves 141 store rubber material during the vulcanization process, allowing the rubber layer to fully combine with the mandrel 11 and the steel wire ring, improving the bonding performance at the interface.

It can be understood that the first crimping sleeve 14 is made of a material with high structural strength. For example, materials such as stainless steel can further improve the structural strength of the tube body.

In some embodiments, the snap-fit groove 112 can be provided on the first crimping sleeve 14, and the snap-fit block 142 can be provided on the mandrel 11, allowing the first crimping sleeve 14 to be "hung" on the mandrel 11.

It can be understood that other fixing methods such as screw locking can also be used to fix the first crimping sleeve 14 on the mandrel 11.

In the ultra-high-pressure hose joint assembly of this embodiment, referring to FIG. 2, the mandrel 11 comprises a plurality of axially spaced annular shoulders 113 with successively reduced diameters. At least one layer of the reinforcement layers 21 is distributed on each shoulder 113, and at least one layer of the reinforcement layers 21 is fixedly connected to the shoulder 113. By providing multiple shoulders 113, connection points with the multiple steel wire layers are formed on the mandrel 11. By fixedly connecting the reinforcement layers 21 to the shoulders 113, the reinforcement layers 21 can be fixedly connected to the mandrel 11, further increasing the connection strength between the tube body 2 and the joint component 1, and preventing the tube body 2 from detaching from the joint component 1 due to high-pressure fluid impact.

It should be noted that the multiple shoulders 113 with successively reduced diameters, forming multiple annular step surfaces on the surface of the mandrel 11 with heights decreasing stepwise. The multiple step surfaces respectively correspond to the layer-by-layer wound reinforcement layers 21, ensuring that each layer of reinforcement layers 21 can be fixedly connected to the shoulder 113. The connection surface between the shoulder 113 and the reinforcement layer 21 is preferably a plane to maximize the contact area between the shoulder 113 and the reinforcement layer 21. Ring-shaped protrusions that change stepwise can be used.

Preferably, when the reinforcement layers 21 are steel wire layers, to prevent axial slippage of the steel wire layers, the reinforcement layers 21 are spot-welded to the shoulders 113, rigidly anchoring each layer and preventing interlayer detachment. When the reinforcement layers 21 are other materials, different connection processes can be used according to the type of reinforcement layers 21.

In some embodiments, the reinforcement layers 21 comprise four layers, wherein the first reinforcement layer 21 is located between the first crimping sleeve 14 and the mandrel 11, and the remaining three steel wire layers are located above the first crimping sleeve 14, and all three steel wire layers are welded to the shoulders 113.

In the ultra-high-pressure hose joint assembly of this embodiment, referring to FIG. 2, the connector 12 is provided with: rubber injection holes 126, the rubber injection hole 126 being in communication with the installation space, rubber is injected into the installation space through the rubber injection holes 126 to form the intermediate rubber layer 22; rubber overflow holes 127, the rubber overflow hole 127 being in communication with the installation space, used to detect whether rubber injection is complete.

Specifically, rubber is injected into the installation space through the rubber injection holes 126 to form the intermediate rubber layer 22 between the joint component 1 and the tube body 2, increasing the sealing performance between the joint component 1 and the tube body 2. When rubber injection ends, rubber overflows from the rubber overflow holes 127, ensuring that the intermediate rubber layer 22 is completely formed and preventing affecting the sealing performance of the joint.

Specifically, after rubber injection, plugs are used to seal the rubber injection holes 126 and the rubber overflow holes 127, further increasing the sealing performance of the joint.

In some embodiments, the installation holes 122 can also be used as the rubber injection holes 126.

In the ultra-high-pressure hose joint assembly of this embodiment, referring to FIG. 1-2, the joint component 1 comprises a second crimping sleeve 15, the second crimping sleeve 15 being sleeved over the outer side of the tube body 2; the second crimping sleeve 15 and the connector 12 are connected by a crimping structure. The crimping structure comprises a protrusion 151 and a groove 128, the protrusion 151 and the groove 128 being provided on the second crimping sleeve 15 and the connector 12 respectively. Specifically, an annular protrusion 151 is provided on a side of the second crimping sleeve 15 close to the connector 12, and a groove 128 corresponding to the protrusion 151 is provided on the connector 12. The second crimping sleeve 15 is crimped onto the connector 12 through the crimping structure, allowing the second crimping sleeve 15 to cover the intermediate rubber layer, further improving the sealing performance of the joint.

In some embodiments, the protrusion 151 and the groove 128 are provided on the connector 12 and the second crimping sleeve 15 respectively.

In the ultra-high-pressure hose joint assembly of this embodiment, referring to FIG. 2, sealing grooves 114 are provided on the outer side surface of the mandrel 11, sealing rings 3 are accommodated within the sealing grooves 114, so that the mandrel 11 and the connector 12 are sealedly connected. Specifically, the sealing grooves 114 are located on a side of the mandrel 11 close to the port. By providing the sealing grooves 114 and the sealing rings 3, leakage between the joint component 1 and the tube body 2 is prevented, increasing the sealing of the joint.

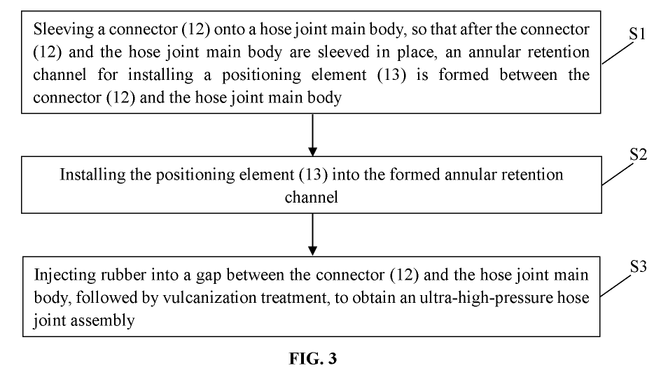

In some embodiments, to prevent the sealing ring material from undergoing plastic flow under ultra-high pressure and being squeezed into the sealing gap, causing sealing failure, a double sealing structure is used within the sealing groove 114 to enhance the pressure-bearing capacity and stability of the sealing ring 3 under ultra-high pressure environments. Specifically, retaining rings or C-rings are provided on both sides of the sealing groove 114. The rigid support of the retaining rings or C-rings confines the sealing ring 3 within the sealing groove 114, reducing the risk of the sealing ring 3 being extruded. Preferably, the contact surface of the retaining ring or C-ring on the side close to the sealing ring 3 is an inclined surface. Further, the inclination angle of the inclined surface is 3°-15°. When ultra-high pressure acts on the inclined surface of the retaining ring or C-ring, a gradient pressure is formed on the contact surface with the sealing ring 3, dispersing the pure radial load borne by the sealing ring, avoiding pressure concentration, and at the same time enhancing the sealing fit. In the assembly process of this embodiment, referring to FIG. 3, the assembly process is applicable to the above-mentioned ultra-high-pressure hose joint assembly, comprising: sleeving the connector 12 onto a hose joint main body, so that after the connector 12 and the hose joint main body are sleeved in place, an annular retention channel for installing a positioning element 13 is formed between the connector 12 and the hose joint main body; installing the positioning element 13 into the formed annular retention channel; injecting rubber into the gap between the connector 12 and the hose joint main body, followed by vulcanization treatment, to obtain an ultra-high-pressure hose joint assembly.

Specifically, the ultra-high-pressure hose joint assembly comprises joint components 1 and a tube body 2. Each joint component 1 comprises a mandrel 11 and a connector 12. The hose joint main body is formed by assembling the mandrels 11 with a hose without an outer rubber layer.

Through the above assembly process, during the assembly of the hose joint, the positioning element 13 is installed into the annular retention channel located between the connector 12 and the hose joint main body, so that the positioning element 13 is located inside the joint component 1, restricting the relative position between the connector 12 and the hose joint main body from the inside out, keeping the relative position between the connector 12 and the hose joint main body unchanged. When the service environment has large pressure fluctuations or high-frequency vibration, it prevents the connector and the hose joint main body from performing irregular movements under external forces, avoiding relative displacement of the joint leading to thread backing off, damage or failure of the seal, further solving the technical problem in the related art that ultra-high-pressure hose joint assemblies are prone to joint leakage. In addition, the above assembly process reduces the installation difficulty of the positioning element 13 and improves the assembly efficiency of the ultra-high-pressure hose joint.

In the assembly process of this embodiment, vulcanization is performed after rubber injection is completed, bonding the rubber body with the connector 12 and the rubber body with the hose joint main body respectively into one body, causing the injected rubber to be vulcanized and set, thereby becoming a stable sealing structure.

In the assembly process of this embodiment, referring to FIG. 1-2, sleeving the connector 12 onto a hose joint main body, so that after the connector 12 and the hose joint main body are sleeved in place, an annular retention channel for installing a positioning element 13 is formed between the connector 12 and the hose joint main body, comprises the following steps: sleeving the connector 12 onto the hose joint main body; aligning the limiting groove 121 on the connector 12 with the positioning groove 111 on the hose joint main body, thereby forming the annular retention channel between the connector 12 and the hose joint main body after the connector 12 and the hose joint main body are sleeved in place.

Specifically, when the positioning groove 111 is provided on the mandrel 11, the axes of the mandrel 11 and the connector 12 can always remain concentric, preventing the connector 12 from moving axially relative to the mandrel 11, thereby achieving axial and radial positioning of the connector 12. By aligning the limiting groove 121 with the positioning groove 111, the positioning element 13 can enter the annular retention channel and be tightly pressed within it, thereby achieving the limiting effect of the positioning element 13 on the connector 12 and the hose joint main body respectively.

Specifically, the annular retention channel is used to accommodate the positioning element 13, and the positioning element 13 is in interference fit with the annular retention channel. The positioning element 13 abuts against both the positioning groove 111 and the limiting groove 121, causing the positioning element 13 to be embedded in the annular retention channel, preventing the positioning element 13 from moving back and forth in the annular retention channel and causing misalignment movement between the connector 12 and the mandrel 11, achieving circumferential, axial, and radial positioning of the connector 12, further improving the sealing performance of the hose joint.

In the assembly process of this embodiment, referring to FIG. 3, installing the positioning element 13 into the formed annular retention channel comprises the following steps: installing a plurality of positioning elements 13 into the annular retention channel in sequence through the installation holes 122 located on the connector 12; after all of the plurality of positioning elements 13 are installed, plugging the installation holes 122 with plugging members 123. Specifically, multiple positioning elements 13 are all located within the annular retention channel. Multiple positioning elements 13 increase the contact area between the positioning elements 13 and the annular retention channel, further preventing relative displacement between the connector 12 and the mandrel 11, further improving the sealing performance between the joint component 1 and the tube body 2. After all positioning elements 13 are installed, the installation holes 122 are plugged with the plugging members 123 to complete the fixation of the positioning elements 13 and prevent it from escaping from the installation holes 122.

Additionally, because the positioning element 13 is in interference fit with the annular retention channel, the positioning element 13 is difficult to move in the annular retention channel. Therefore, when installing the positioning element 13, external force is needed to drive the positioning element 13 into the annular retention channel.

In the assembly process of this embodiment, referring to FIG. 3, before sleeving the connector 12 onto the hose joint main body, it comprises the following steps: preparing a hose without an outer rubber layer, sleeving a first crimping sleeve 14 and a mandrel 11 onto the hose without the outer rubber layer in sequence; fixedly connecting the hose without the outer rubber layer to the first crimping sleeve 14 and the mandrel 11 respectively; winding the winding material onto the surface of the hose without the outer rubber layer to form the hose joint main body. Through the above assembly process, the mandrel 11 and the hose without the outer rubber layer are connected into one body, achieving the embedding of the first crimping sleeve 14 within the multiple layers of reinforcement layers 21, increasing the structural strength of the tube body 2.

Specifically, processes such as crimping or threaded connection can be used to fixedly connect the hose without the outer rubber layer to the first crimping sleeve 14 and the mandrel 11 respectively.

Specifically, the hose without the outer rubber layer is a tube body 2 comprising only at least one layer of reinforcement layer 21.

In some embodiments, to prepare the hose without the outer rubber layer, an existing hose joint can be used directly. Corresponding to the joint component 1, part of the outer rubber layer and inner rubber layer of the existing hose joint are stripped, and the outer reinforcement layers 21 are peeled off, leaving only at least one layer of reinforcement layer 21. The retained at least one layer of reinforcement layer 21 also has a layer of intermediate rubber wound on it.

In some embodiments, the mandrel 11 and the first crimping sleeve 14 are connected by a snap-fit structure. The snap-fit structure comprises: a snap-fit groove 112, the snap-fit groove 112 being provided on the mandrel 11; a snap-fit block 142, the snap-fit block 142 being provided on the first crimping sleeve 14, the snap-fit block 142 engaging with the snap-fit groove 112. By providing the snap-fit structure, the snap-fit block 142 is engaged into the snap-fit groove 112, allowing the first crimping sleeve 14 to be "hung" on the mandrel 11, making the first crimping sleeve 14 and the mandrel 11 one body, and thus making the tube body 2 and the mandrel 11 one body, increasing the connection strength between the tube body and the mandrel 11, and preventing the tube body 2 from detaching from the joint component 1. Therefore, before fixedly connecting the hose without the outer rubber layer to the first crimping sleeve 14 and the mandrel 11, it is necessary to first engage the snap-fit block 142 into the snap-fit groove 112.

In some embodiments, the reinforcement layers 21 are steel wire layers, having strong strength and flexibility.

In the assembly process of this embodiment, referring to FIG. 3, winding the winding material onto the surface of the hose without the outer rubber layer to form the hose joint main body comprises the following steps: winding the reinforcement layer by layer onto the surface of the hose without the outer rubber layer, thereby forming multiple layers of reinforcement layers 21 on the hose, winding a layer of intermediate rubber on the surface of each reinforcement layer 21. Through the above setting, a structure of one layer of winding material and one layer of intermediate rubber is formed, further improving the sealing performance of the hose joint.

In the assembly process of this embodiment, referring to FIG. 3, winding the reinforcement layer by layer onto the surface of the hose without the outer rubber layer, thereby forming multiple layers of reinforcement layers 21 on the hose, winding a layer of intermediate rubber on the surface of each reinforcement layer 21, comprises the following steps: at least one layer of the reinforcement layers 21 is distributed on each shoulder 113 located on the mandrel 11, fixedly connecting at least one layer of the reinforcement layers 21 to the corresponding shoulder 113. Through the above assembly process, by fixedly connecting the reinforcement layers 21 to the shoulders 113, each layer of reinforcement layer 21 is fixedly connected to the corresponding shoulder 113, further increasing the connection strength between the tube body 2 and the joint component 1, and preventing the tube body 2 from detaching from the joint component 1 due to high-pressure fluid impact.

Preferably, when the reinforcement layers 21 are steel wire layers, the reinforcement layers 21 are spot-welded to the shoulders 113.

In the assembly process of this embodiment, referring to FIG. 3, before sleeving the connector 12 onto the hose joint main body, it comprises the following steps: sleeving a second crimping sleeve 15 onto the hose joint main body. Through this process, before installing the connector 12, the sleeving of the second crimping sleeve 15 is completed first, avoiding affecting the installation of the second crimping sleeve 15 after the connector 12 is installed.

In the assembly process of this embodiment, referring to FIG. 3, after installing the positioning element 13 into the formed annular retention channel, it comprises the following steps: fixedly connecting the second crimping sleeve 15 to the connector 12 and the hose joint main body respectively. Specifically, after completing the installation of the positioning element 13, processes such as crimping or threaded connection are used to fixedly connect the second crimping sleeve 15 to the connector 12 and the hose joint main body respectively as a whole.

Specifically, the second crimping sleeve 15 and the connector 12 are connected by a crimping structure. The crimping structure comprises a protrusion 151 and a groove 128, the protrusion 151 and the groove 128 being provided on the second crimping sleeve 15 and the connector 12 respectively. Therefore, before fixedly connecting the second crimping sleeve 15 to the connector 12 and the hose joint main body respectively, it is necessary to first embed the protrusion 151 into the groove 128, further improving the connection strength between the joint component 1 and the tube body 2.

In the assembly process of this embodiment, referring to FIG. 3, injecting rubber into the gap between the connector 12 and the hose joint main body comprises the following steps: injecting rubber into the gap between the connector 12 and the hose joint main body through rubber injection holes 126 to form an intermediate rubber layer 22, until rubber without any bubbles continuously overflows from rubber overflow holes 127; sealing the rubber injection holes 126 and the rubber overflow holes 127 with plugs. By injecting rubber into the gap between the connector 12 and the hose joint main body through the rubber injection holes 126, the intermediate rubber layer 22 is formed between the connector 12 and the hose joint main body. The rubber bonds each layer of winding material and each layer of intermediate rubber into a whole, embedding the multiple layers of reinforcement layers 21 in the intermediate rubber layer 22, increasing the sealing performance between the joint component 1 and the tube body 2. By checking the overflow condition of the rubber overflow holes 127, it is ensured that sufficient rubber can be injected into the gap, ensuring that the intermediate rubber layer 22 is completely formed, preventing affecting the sealing performance of the joint. By sealing the rubber injection holes 126 and the rubber overflow holes 127 with plugs, water and dust prevention is achieved, further ensuring the sealing of the ultra-high-pressure hose joint.

In the assembly process of this embodiment, before sleeving the connector 12 onto the hose joint main body, it comprises the following steps: performing sealing treatment between the connector 12 and the mandrel 11, assembling the sealing rings 3 into the sealing grooves 114 on the mandrel 11. Specifically, it can prevent leakage between the connector 12 and the mandrel 11, increasing the sealing of the joint.

Below is an optional embodiment of the assembly process in the present disclosure:

First, prepare a hose without an outer rubber layer. Strip the inner rubber layer and outer rubber layer matching the joint component 1 from the raw material of the tube body 2 according to the structural dimensions. Peel off the other steel wire layers except the innermost winding steel wire layer. Sleeve the first crimping sleeve 14 onto the outer side of the hose without the outer rubber layer, and axially press-fit the mandrel 11 into the hose without the outer rubber layer. Use a crimping method to press-fit the mandrel 11, the hose without the outer rubber layer, and the first crimping sleeve 14 into one body. Then wind a layer of intermediate rubber on the outer surfaces of the hose without the outer rubber layer and the first crimping sleeve 14, and rewind the peeled second layer of steel wire onto the first crimping sleeve 14 and the mandrel 11. The second layer of steel wire and the shoulder 113 on the mandrel 11 are welded into one body by welding. The weld size between the second layer of steel wire and the shoulder 113 meets the use requirements of the ultra-high-pressure hose joint, and the heat generated during the welding process must not damage each rubber layer. Then sequentially wind the third layer and fourth layer of steel wire, and isolate each steel wire layer with an intermediate rubber layer. Weld each steel wire layer and the mandrel 11 into one body, achieving reliable connection between each steel wire layer and the mandrel 11. The weld size between each layer of steel wire and the shoulder 113 meets the use requirements of the ultra-high-pressure hose joint. After the above steps, the hose joint main body is formed.

After forming the hose joint main body, assemble the sealing rings 3 into the sealing grooves 114. Then sequentially sleeve the second crimping sleeve 15 and the connector 12 axially onto the hose joint main body. After aligning the limiting groove 121 with the positioning groove 111, install each positioning element 13 into the annular retention channel in sequence through the reserved installation holes 122 on the connector 12, and uniformly fill the annular retention channel. After all sufficient positioning elements 13 are installed in place, use plugging members 123 to plug the installation holes 122 to prevent the positioning elements 13 from falling out during handling or storage. The end of the plugging member 123 is made with a groove matching the size of the positioning element 13. After the plugging members 123 are installed in place, the positioning elements 13 can be reliably fixed, preventing them from falling out of the installation holes 122. Then embed the protrusion 151 on the second crimping sleeve 15 into the groove 128, use a crimping process to crimp the connector 12 and the second crimping sleeve 15 into one body, and then crimp the second crimping sleeve 15 and the tube body 2 into one body.

After the connector 12 and the hose joint main body are reliably connected into one body, inject liquid rubber into the gap between the connector 12 and the hose joint main body through the rubber injection holes 126. After the rubber without any bubbles continuously overflows from the rubber overflow holes 127, use plugs to seal the rubber injection holes 126 and the rubber overflow holes 127. Then place the ultra-high-pressure hose joint into a vulcanization bed for vulcanization. After vulcanization treatment, the hose and the joint can be reliably cured together. The ultra-high-pressure hose joint has good anti-pull-out performance in environments with ultra-high-pressure pulsation and ultra-high pressure. The ultra-high-pressure hose joint can meet the use and assembly requirements for environments with large pressure fluctuations or high-frequency vibration.

It should be noted that the terms "first", "second", etc. in the specification and claims of the present application and the above drawings are used to distinguish similar objects and are not necessarily used to describe a specific order or sequence. It should be understood that data used in this way may be interchanged under appropriate circumstances so that the embodiments of the present application described herein can be implemented in an order other than those illustrated or described herein. Furthermore, the terms "comprising" and "having" and any variations thereof are intended to cover non-exclusive inclusion. For example, a process, method, system, product, or device that comprises a series of steps or units is not limited to the listed steps or units, but may include steps or units not explicitly listed or inherent to these processes, methods, products, or devices.

Optionally, specific examples in this embodiment can refer to the examples described in the above embodiments, and this embodiment will not be described again here.

The serial numbers of the above embodiments of the present application are for description only and do not represent the superiority or inferiority of the embodiments.

In the above embodiments of the present application, the description of each embodiment has its own focus. For parts not described in detail in a certain embodiment, reference can be made to the related description of other embodiments.

The above are only preferred embodiments of the present application and are not intended to limit the present application. For those skilled in the art, various modifications and changes can be made to the present application. Any modification, equivalent replacement, improvement, etc. made within the spirit and principle of the present application shall be included within the scope of protection of the present application.

What is claimed is:

1. An ultra-high-pressure hose joint assembly, comprising joint components and a tube body, wherein each joint component comprises:
a mandrel, the tube body being sleeved over an outer side of the mandrel, the mandrel being in communication with the tube body;
a connector, at least a part of the connector being sleeved on the mandrel;
a positioning element, the positioning element being located at a connection between the mandrel and the connector, the positioning element being used to restrict a relative position between the connector and the mandrel.

2. The ultra-high-pressure hose joint assembly according to claim 1, wherein an installation space for inserting the tube body is formed between the connector and the mandrel, and the connector is fixedly connected to an outer side of the tube body located within the installation space.

3. The ultra-high-pressure hose joint assembly according to claim 2, wherein a positioning groove is provided on the mandrel, one end of the positioning element abuts against the connector, and an other end of the positioning element abuts against the positioning groove.

4. The ultra-high-pressure hose joint assembly according to claim 3, wherein the connector comprises a limiting groove corresponding to the positioning groove, the limiting groove abuts against the positioning element, the limiting groove and the positioning groove together enclose to form an annular retention channel for accommodating the positioning element, and the positioning element is in interference fit with the annular retention channel.

5. The ultra-high-pressure hose joint assembly according to claim 4, wherein the annular retention channel is an annular channel, and the positioning element is in interference fit with the annular channel.

6. The ultra-high-pressure hose joint assembly according to claim 5, wherein the connector comprises:
installation holes, the installation holes penetrating through the connector, the installation holes being in communication with the annular retention channel, the positioning element entering the annular retention channel through the installation holes;
plugging members, the plugging members being detachably connected to the installation holes.

7. The ultra-high-pressure hose joint assembly according to claim 2, wherein the tube body comprises multiple layers of reinforcement layers and an intermediate rubber layer covering the multiple layers of reinforcement layers.

8. The ultra-high-pressure hose joint assembly according to claim 7, wherein first rubber receiving grooves are provided on a side of the connector close to the tube body, and at least a portion of the intermediate rubber layer is located within the first rubber receiving grooves.

9. The ultra-high-pressure hose joint assembly according to claim 7, wherein each joint component comprises a first crimping sleeve, and the first crimping sleeve is embedded within the multiple layers of reinforcement layers.

10. The ultra-high-pressure hose joint assembly according to claim 9, wherein the mandrel and the first crimping sleeve are connected by a snap-fit structure.

11. The ultra-high-pressure hose joint assembly according to claim 7, wherein the mandrel comprises a plurality of shoulders with successively reduced diameters, at least one layer of the reinforcement layers is distributed on each shoulder, and at least one layer of the reinforcement layers is fixedly connected to a shoulder.

12. The ultra-high-pressure hose joint assembly according to claim 1, wherein each joint component comprises a second crimping sleeve, the second crimping sleeve being sleeved over an outer side of the tube body;
the second crimping sleeve and the connector are connected by a crimping structure.

13. The ultra-high-pressure hose joint assembly according to claim 7, wherein rubber injection holes are provided on a peripheral wall of the connector, the rubber injection holes being used to inject rubber material into the installation space to form the intermediate rubber layer through vulcanization.

14. The ultra-high-pressure hose joint assembly according to claim 6, characterized by further comprising elastic parts, the elastic parts being disposed between the plugging members and the positioning element; both ends of each elastic part respectively abut against a plugging member and the positioning element.

15. The ultra-high-pressure hose joint assembly according to claim 1, wherein sealing ring grooves are provided on a peripheral wall at an end of the connector, sealing rings are provided within the sealing ring grooves; a retaining ring or a C-ring is respectively arranged on both sides of each sealing ring; a contact surface of the retaining ring or the C-ring on a side close to each sealing ring is an inclined surface.

16. An assembly process, characterized by comprising:
sleeving a connector onto a hose joint main body, so that after the connector and the hose joint main body are sleeved in place, an annular retention channel for installing a positioning element is formed between the connector and the hose joint main body;
installing the positioning element into the formed annular retention channel;
injecting rubber into a gap between the connector and the hose joint main body, followed by vulcanization treatment, to obtain an ultra-high-pressure hose joint assembly.

17. The ultra-high-pressure hose joint assembly process according to claim 16, wherein sleeving the connector onto the hose joint main body, so that after the connector and the hose joint main body are sleeved in place, the annular retention channel for installing the positioning element is formed between the connector and the hose joint main body, comprises following steps:
sleeving the connector onto the hose joint main body;
aligning a limiting groove on the connector with a positioning groove on the hose joint main body, thereby forming the annular retention channel between the connector and the hose joint main body after the connector and the hose joint main body are sleeved in place.

18. The ultra-high-pressure hose joint assembly process according to claim 16, wherein installing the positioning element into the formed annular retention channel comprises following steps:
installing a plurality of the positioning elements into the annular retention channel in sequence through installation holes located on the connector;
after all of the plurality of positioning elements are installed, plugging the installation holes with plugging members.

19. The ultra-high-pressure hose joint assembly process according to claim 17, wherein before sleeving the connector onto the hose joint main body, comprises following steps:
preparing a hose without an outer rubber layer, sleeving a first crimping sleeve and a mandrel onto the hose without the outer rubber layer in sequence;
fixedly connecting the hose without the outer rubber layer with the first crimping sleeve and the mandrel respectively;
winding reinforcement layer by layer onto a surface of the hose without the outer rubber layer, thereby forming multiple layers of reinforcement layers on the hose, at least one layer of the reinforcement layers being distributed on each shoulder located on the mandrel, fixedly connecting at least one layer of the reinforcement layers to a corresponding shoulder; winding a layer of intermediate rubber on a surface of each reinforcement layer to form the hose joint main body.

20. The ultra-high-pressure hose joint assembly process according to claim 16, wherein injecting rubber into the gap between the connector and the hose joint main body comprises following steps:
injecting rubber into the gap between the connector and the hose joint main body through rubber injection holes to form an intermediate rubber layer, until rubber without any bubbles continuously overflows from rubber overflow holes;
sealing the rubber injection holes and the rubber overflow holes with plugs.
